(19) United States
(12) Patent Application Publication
(10) Pub. No.: US 2023/0267379 A1
(43) Pub. Date: Aug. 24, 2023

(54) METHOD AND SYSTEM FOR GENERATING AN AI MODEL USING CONSTRAINED DECISION TREE ENSEMBLES

(71) Applicant: Australia and New Zealand Banking Group Limited, Docklands, Victoria (AU)

(72) Inventor: Warren Du Preez, Docklands, Victoria (AU)

(21) Appl. No.: 18/003,948

(22) PCT Filed: Jun. 30, 2021
(86) PCT No.: PCT/AU2021/050703

§ 371 Date: Dec. 30, 2022

(30) Foreign Application Priority Data
Jun. 30, 2020 (AU) 2020902198

(51) Int. Cl. G06N 20/20

(52) U.S. Cl. CPC G06N 20/20

(57) ABSTRACT

A method for generating an artificial intelligence model for determining probability of rainfall, by applying a decision tree ensemble learning process on a dataset, the method comprising: receiving a first dataset comprising at least two variables; determining at least one split criteria for each variable within the first dataset; partitioning the first dataset based on each determined split criteria; calculating a measure of directionality for each partition of data; performing a constrained node selection process by selecting a candidate variable and split criteria, wherein the selection is made to keep a consistent directionality for the selected variable based on existing nodes; updating a directionality table at the end of a constrained node selection; reiterating the constrained node selection process for every node selection throughout the decision tree ensemble learning process until an ensemble model is generated; and processing a second dataset with the generated ensemble model to determine probability of rainfall; wherein the first dataset contains data received from one or more sensors, the received data including data pertaining to temperature.

### TECHNICAL FIELD

Described embodiments generally relate to generating an artificial intelligence model, such as a decision tree ensemble. In particular, embodiments relate to generating a supervised classification machine learning model under a directionality constraint.

### BACKGROUND

Artificial intelligence models are often used to make predictions about real-world events, such as an amount of rainfall that is to occur, whether loan seekers will default on payments, whether interest rates or share prices will increase, public preferences for government in the future, ecological modelling, or likelihood of a virus to be contracted by a person. These are just a small subset of possible examples, and there are many applications across many disciplines and industries that may use artificial intelligence models.

Artificial intelligence models may be generated by applying supervised classification learning methods to datasets. In the art of supervised classification modelling, the generation of an ensemble of decision trees through learning techniques such as gradient boosted trees can be used for prediction tasks.

In decision tree ensemble learning, the prediction accuracy of the model is considered to be the objective. Metrics are applied to constrain the learning process in order to optimise the likelihood of accurate predictions.

However, in some modelling applications, there is a high complexity in the relationship between each variable within the model and its effect on the target variable of the model. This can result in uncertainty and a lack of trust in the model, as the generated decision tree ensemble may be deemed deficient in its ability to be explained.

Embodiments disclosed below are designed to ameliorate the aforementioned shortcomings, or at least to provide a useful alternative.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each of the appended claims.

### SUMMARY

Some embodiments relate to a method for generating an artificial intelligence model for determining probability of rainfall, by applying a decision tree ensemble learning process on a dataset, the method comprising: receiving a first dataset comprising at least two variables; determining at least one split criteria for each variable within the first dataset; partitioning the first dataset based on each determined split criteria; calculating a measure of directionality for each partition of data; performing a constrained node selection process by selecting a candidate variable and split criteria, wherein the selection is made to keep a consistent directionality for the selected variable based on existing nodes; updating a directionality table at the end of a constrained node selection; reiterating the constrained node selection process for every node selection throughout the decision tree ensemble learning process until an ensemble model is generated; and processing a second dataset with the generated ensemble model to determine probability of rainfall. The first dataset may contain data received from one or more sensors. The received data may include data pertaining to temperature.

Some embodiments relate to a method for generating an artificial intelligence model for determining probability of default on a loan, by applying a decision tree ensemble learning process on a dataset, the method comprising: receiving a first dataset comprising at least two variables; determining at least one split criteria for each variable within the first dataset; partitioning the first dataset based on each determined split criteria; calculating a measure of directionality for each partition of data; performing a constrained node selection process by selecting a candidate variable and split criteria, wherein the selection is made to keep a consistent directionality for the selected variable based on existing nodes; updating a directionality table at the end of a constrained node selection; reiterating the constrained node selection process for every node selection throughout the decision tree ensemble learning process until an ensemble model is generated; processing a second dataset with the generated ensemble model to determine probability of default. The first dataset may contain financial data relating to one or more financial participants. The financial data may include data pertaining to a repayment history.

Some embodiments relate to a method for generating an artificial intelligence model by applying a decision tree ensemble learning process on a dataset, the method comprising:
receiving a dataset comprising at least two variables;
determining at least one split criteria for each variable within the dataset;
partitioning the dataset based on each determined split criteria;
calculating a measure of directionality for each partition of data;
performing a constrained node selection process by selecting a candidate variable and split criteria, wherein the selection is made to keep a consistent directionality for the selected variable based on existing nodes;
updating a directionality table at the end of a constrained node selection; and
reiterating the constrained node selection process for every node selection throughout the decision tree ensemble learning process until an ensemble model is generated.

According to some embodiments, the constrained node selection process comprises:
generating groups of split criterions for each of one or more variables of the dataset, creating one or more variable and split criteria combinations;
copying the dataset for every variable and split criteria combination;
partitioning each copied dataset by its associated split criteria for a variable and store resulting partitioned datasets each in a candidate table for each variable and split criteria combination;
calculating a measure of homogeneity and directionality for each candidate table;
storing all candidate tables which pass directionality criterion in a table set;
selecting one of the candidate tables of the table set which has the optimal measure of homogeneity;
storing the associated variable and split criteria combination of the selected candidate table as a chosen candidate for the node; and
storing the partitioned data from selected table to use as new datasets for selection of decision nodes or leaf nodes, which branch from the selected node.

In some embodiments, updating a directionality table comprises entering directionality information of the selected candidate variable and split value into the directionality table. In some embodiments, the directionality table is also updated with cumulative weighted information gain calculation for the associated variable. According to some embodiments cumulative weighted information gain for the associated variable is calculated at the end of the learning process.

According to some embodiments, the directionality table is not updated with directionality information for the selected candidate variable when the directionality table already contains directionality information for the selected candidate variable.

In some embodiments, candidate tables pass the directionality criterion if they match directionality with entries in the directionality table. In some embodiments, candidate tables pass the directionality criterion if they have no entries in the directionality table.

According to some embodiments, the method is applied to random forest or a gradient boosted trees learning methods.

In some embodiments, the dataset comprises one or more continuous variables.

According to some embodiments, one or more split values are assigned to a candidate table for a continuous variable.

In some embodiments, the dataset comprises one or more categorical variables.

According to some embodiments, two or more categories are assigned to a candidate table for a categorical variable instead of a one or more split values.

According to some embodiments, the measure of homogeneity is entropy. According to some embodiments, the measure of homogeneity is Gini.

Some embodiments further comprising presenting the user with weighted information gain and directionality information for each variable used in the ensemble at the end of the learning process.

According to some embodiments, the weighted information gain and directionality information for each variable is sorted based on weighted information gain.

In some embodiments, the weighted information gain is calculated per leaf node, whereby each decision node in which the leaf node is dependent upon is factored into the weighted information gain calculation. In some embodiments, the weighted information gain and directionality information per variable per leaf node is available to be presented or is presented to the user.

According to some embodiments, if two or more candidate decision nodes selected at a processing stage, whereby each use the same variable and have conflicting directionality, and no directionality is yet determined, the selected node or nodes of a directionality which best meet a conflict criteria are kept, and the other selected node or nodes of another directionality are rejected. In some embodiments, the conflict criteria is highest information gain or weighted information gain of a node; or highest total information gain or total weighted information gain of nodes grouped by directionality. In some embodiments, the conflict criteria is largest number of observations of a node, or largest number of observations grouped by their respective node's directionality. In some embodiments, the conflict criteria is the earliest selection time of a node. In some embodiments, the conflict criteria is largest number of candidate decision nodes grouped by directionality.

Some embodiments relate to a system for constraining a decision tree ensemble machine learning process to generate an artificial intelligence model for a dataset, the system comprising:
a processor;
memory storing program code that is accessible and executable by the processor; and
wherein, when the processor executed the program code, the processor is caused to:
   apply directionality as a criterion for a constrained node selection process in order to select a selected candidate variable and split value for a node;
   update a directionality table at the end of a constrained node selection; and
   reiterate the process for every node selection throughout a decision tree ensemble build.

Some embodiments relate to a system for constraining a decision tree ensemble machine learning process to generate an artificial intelligence model for a dataset, the system comprising:
a processor;
memory storing program code that is accessible and executable by the processor; and
wherein, when the processor executed the program code, the processor is caused to perform the method of some previously described embodiments.

### BRIEF DESCRIPTION OF THE DRAWINGS

FIG. 1 is a block diagram of computing components of a system for generating an artificial intelligence model using a constrained decision tree ensemble according to some embodiments;

FIG. 2 is a flow diagram illustrating a method of building tree ensembles performed by the system of FIG. 1 in some embodiments;

FIG. 3 is a diagram corresponding to a decision tree generated by methods of the art;

FIG. 4 is a diagram corresponding to a decision tree generated by the system of FIG. 1 applying the method of FIG. 2 in some embodiments;

FIG. 5 is a diagram corresponding to two decision trees of a decision tree ensemble generated by the system of FIG. 1 applying the method of FIG. 2 in some embodiments; and

FIG. 6 is a diagram corresponding to a decision tree generated by the system of FIG. 1 applying the method of FIG. 2 in some embodiments.

### DETAILED DESCRIPTION

Described embodiments generally relate to generating an artificial intelligence model, such as a decision tree ensemble. In particular, embodiments relate to generating a supervised classification machine learning model under a directionality constraint.

Directionality in the context of decision trees may be defined based on a comparison between different split branches at a node, whereby the comparison is between each of the respective branches' ratio of positive events to total events, and a ranking based on the magnitude of each respective branches ratio. A subsequent directionality label is based upon the ranking of each branch and each of the branches position in relation to each other with the split value criteria.

For example, with a two branch split at a single split value of a variable v at a node, the lower values of v to the split value of v may be considered on the left side of the split value of v, and the higher values to the split value v may be considered on the right side of the split value of v. If the ratio of positive events to total events for the lower values of v is higher than the ratio for the higher values of v, the left side might then be ranked higher than the right side, and the node might subsequently be labelled as left side directionality. And conversely, if the ratio of positive events to total events for the higher values of v is higher than the same ratio for the lower values of v, the right side might then be ranked higher than the right side, and the node might subsequently be labelled as right side directionality.

Subsequently, for a tree or ensemble to comply with a directionality constraint, all the re-occurrences of using split values of the variable v as a split criteria at nodes, the node must have the same labelled directionality according to some embodiments. In some embodiments, applying ranking may be particularly pertinent for nodes with multiple split values and/or more than two branches.

In some embodiments for categorical variables, a similar approach to determining and applying directionality may be adopted. For example a colour variable c with categories of red, blue and green may be applied at a node. The ratio of positive events to total events for the red occurrences of c may be the highest, followed by the ratio of positive events to total events for the green occurrences of c, with the ratio of positive events to total events for the blue occurrences of c being the lowest. In this case the red occurrences at the node might then be ranked higher than the other colours with blue being the lowest ranked, and the node might subsequently be labelled as “red green blue” directionality. Subsequent occurrences of nodes with split criteria based on variable c will have the same directionality if they are also determined to be labelled “red green blue”. In some other embodiments, the particular ranking of a subset of the categories of a variable of three or more categories may define a “weaker” directionality, i.e. directionality based on a single category with the highest ranking out of three categories, such as “red”.

Some embodiments comprise a method whereby a novel directionality constraint is made upon the generation of decision tree ensembles, which allows for singular inferences to be drawn relating to each occurring variable's effect on the target variable, with the aim to more easily explain learnt decision tree ensemble models.

Decision tree ensembles are comprised of decision nodes (including root nodes), each of which comprise a variable and a split criteria. The variable and split criteria are selected by a selection process. The selection process entails selection of a variable and split criteria made between a candidate list of variables and corresponding split criteria, whereby selection between candidates from the list is based on the candidate which produces in the optimal measurement of homogeneity (i.e. lowest entropy) for the dataset when split by candidate variable and split criteria.

Following selection of a decision node, the dataset is partitioned based on the split criteria. The resulting partitioned datasets are used as a basis for subsequent node selections, which branch from the previous selected node, a method called recursive partitioning.

In the art, when learning a decision tree ensemble model, measures such as entropy are used to select the optimal candidate variable and split criteria for a decision node from a list of variables and split criteria.

For continuous variables, a decision node comprises a variable and one or more split values which may be accompanied by one or more inequality relations which form a split criteria.

If a sufficient majority of the observations in a partitioned dataset of a branch are positive or a sufficient majority of the observations are negative, the partitioned dataset is deemed classified, and the branch is appended with a leaf node.

If training data of a branch does not have a sufficient majority of observations of the target variable being positive or negative, a decision node is selected and appended to the branch.

When the decision tree ensemble is learnt, the decision tree ensemble likely contains many instances of a variable at decision nodes.

In a hypothetical learnt ensemble in the art used to predict rainfall, a temperature variable may predict rainfall above a temperature of 30° C. at one leaf, but it may also predict rainfall below 10° C. at another leaf. It may not predict rainfall below 30° C. or above 10° C. at the same decision nodes respectively.

Both of the temperature decision nodes are described to exhibit different directionality from each other. This is because there are a greater proportion of positive observations above the split value than below the split value in the case that the split value is 30° C., while there is also a greater proportion of positive values below the split value than above the split value in the case the split value is 10° C.

However a desired generalisation may be to say that higher temperatures predict rainfall throughout learnt decision tree ensembles, which may be very improbable to occur in the art.

In the art, for many occurrences of a variable, multiple inferences are likely to be made to explain the variable's effect on the target variable in the model.

Embodiments described below may allow for singular inferences to be made for each occurring variable's effect on the target variable, allowing the results of learnt decision tree ensemble models to be more easily explained.

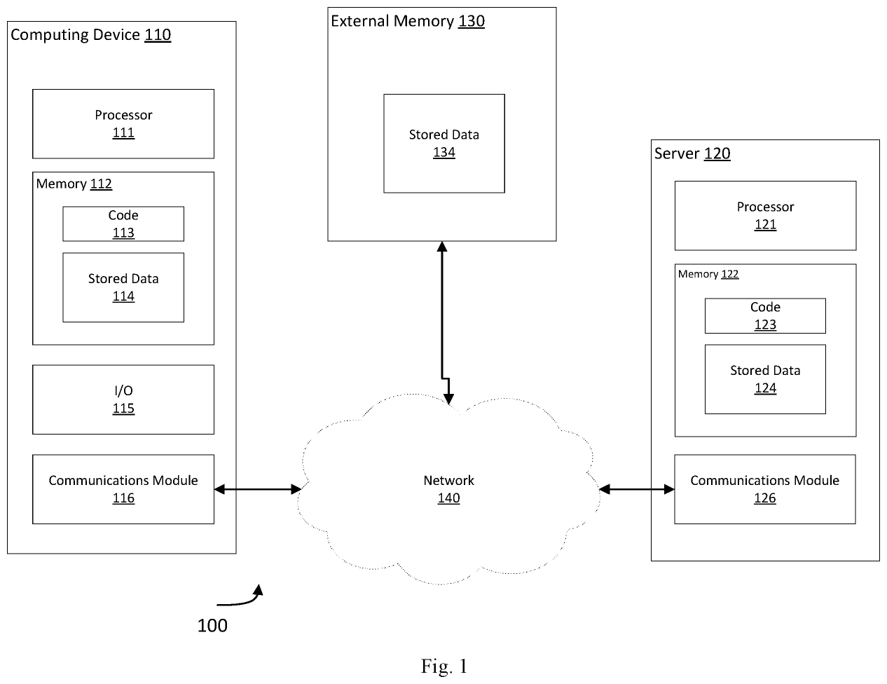

FIG. 1 shows a system 100 for generating an artificial intelligence model, such as a decision tree ensemble.

System 100 includes a computing device 110. Computing device 110 may be a laptop, desktop or other computing device. Computing device 110 comprises a processor 111 and memory 112 that is accessible to processor 111. Processor 111 may comprise one or more microprocessors, central processing units (CPUs), application specific instruction set processors (ASIPs), or other processors capable of reading and executing instruction code.

Memory 112 may comprise one or more volatile or non-volatile memory types, such as RAM, ROM, EEPROM, or flash, for example. Memory 112 may be configured to store code 113 and data 114. Processor 111 may be configured to access memory 112 to read and execute code 113 stored in memory 112, to read and load stored data 114, and to perform processes specified in code 113 to process stored data 114.

Computing device 110 may further comprise user input and output 115, and communications module 116. Communications module 116 may facilitate communication via a wired communication protocol, such as USB or Ethernet, or via a wireless communication protocol, such as Wi-Fi, Bluetooth or NFC, for example. Processor 111 may be configured to communicate with user input and output 115, and communications module 116.

User input and output 115 may comprise one or more of an output display screen, an input mouse, an input keyboard or other I/O devices.

System 100 further comprises network 140, a server 120 and external memory 130. Computing device 110 may be configured to use communications module 116 to communicate via network 140 to external or remote devices, such as external memory 130 or server 120.

Network 140 may comprise direct connections between hosts, enterprise networks, Internet, local area networks or any other networks both wired or wireless.

External memory 130 may comprise one or more of flash memory, external hard drives, cloud storage or any other data storage medium external to computing device 110.

Server 120 may be a single server, a service system, a cloud-based server or server system, or other computing device providing centralised servers to computing devices such as computing device 110. Server 120 comprises processor 121, and memory 122 accessible to processor 121. Server 120 is capable of storing code 123 and data 124 in memory 122. Processor 121 may be configured to read and execute code 123 to load stored data 124, and perform processes specified in code 123 to process stored data 124.

Server 120 further comprises a communications module 126. Communications module 126 may facilitate communication between server 120 and other devices via a wired communication protocol, such as USB or Ethernet, or via a wireless communication protocol, such as Wi-Fi, Bluetooth or NFC, for example.

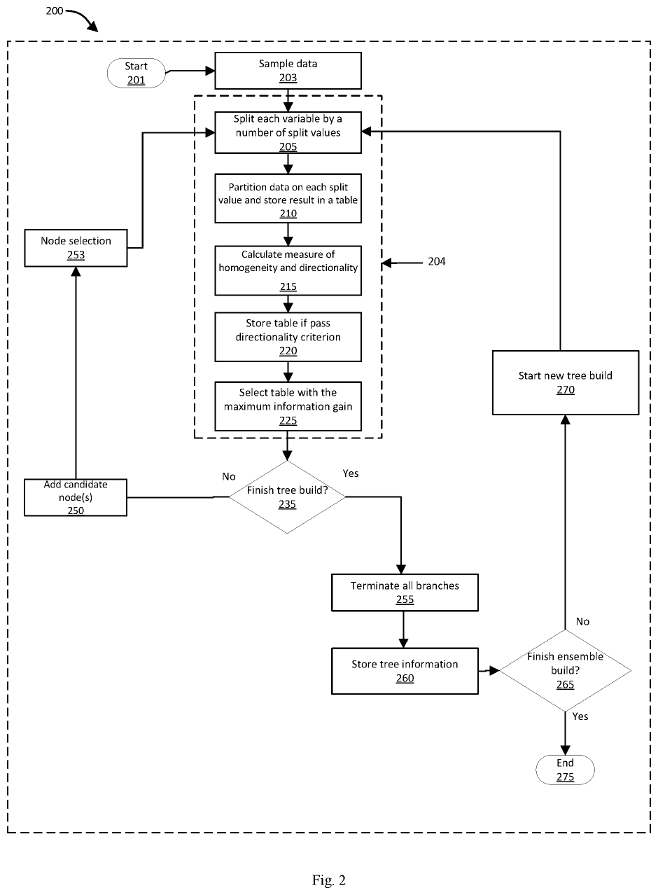

FIG. 2 shows a method 200 of generating an artificial intelligence model by using a decision tree ensemble learning process, whereby a directionality constraint is placed on the learning process, as performed by system 100 in some embodiments. Method 200 may be performed by processor 111 executing program code 113.

Method 200 begins with step 201, at which processor 111 is provided with an initial dataset from external stored data 134. The initial dataset contains two or more variables, one of which is designated as the target variable, being the variable that is desired to be predicted by using a generated model from method 200. For example, where it is desired to generate a model to predict rainfall, the initial dataset may contain a variable for temperature, humidity, year, month of the year, time of day, altitude of measurement, longitude, latitude of measurement, as well as a variable indicating whether rainfall was measured.

The variables in the initial dataset may be continuous or categorical variables.

Once the dataset is made available to the processor 111, the processor 111 executing program code 113 is caused to sample the dataset at step 203. Pre-processing methods such as principle component analysis (PCA) may be performed prior or after sampling at step 203, which may affect the sampled dataset, such as reducing the number of variables of the sampled dataset.

Also at step 203, the processor 111 may be caused to generate a table, which lists the directionality status of each variable of the sampled dataset, called a directionality table and stored in memory 112, 130, or 122. The directionality status for each variable will initially be undetermined.

Once the processor 111 has completed sampling of the dataset and any pre-processing of the dataset, the processor 111 executing program code 113 is further caused to begin a constrained node selection process 204.

The first step for constrained node selection process 204 begins where the processor 111 executing program code 113 is caused to generate a number of split criteria for each variable at step 205. The split criteria may define a criteria for partitioning data based on its value for the associated variable. For example, where the dataset relates to rainfall data, the split criteria may be for the temperature variable, whereby the criteria consists of a temperature value and an inequality sign, the combination of which is used to partition data. The result of the generation is a candidate list of split criteria and variable pairings for the decision node, which may be referred to as the candidate pairing list. On subsequent iterations of the step 205 in method 200, the input data is not necessarily the sampled data, but it may be intermediate partitioned datasets. The process follows recursive partitioning methods.

After creating the candidate pairing list, at step 210 the processor 111 executing program code 113 is further caused to create a candidate table for each candidate pairing, whereby each candidate table contains the dataset partitioned by its respective candidate variable and split criteria.

After each table of the dataset is partitioned in step 210, the processor 111 executing program code 113 is further caused to calculate a measure of homogeneity and directionality for each candidate table step 215. In some embodiments, the measure of homogeneity comprises a measure of entropy or a Gini coefficient.

Proceeding step 215, at step 220 the processor 111 executing program code 113 is further caused to store candidate tables which pass a directionality criterion within a table set in memory 112, 130 or 122. Candidate tables which do not pass the directionality criterion are not stored in the table set. The directionality criterion may be determined based on the directionality table. The directionality table may be used as a reference directionality criteria for step 220, by comparing the directionality for each candidate table calculated at step 215 against the directionality criterion stored in the directionality table. If the directionality is undetermined for the candidate variable, the candidate table is deemed to pass directionality.

If there are no candidate tables which pass directionality for the node, processor 111 may be caused to perform further processing. The further processing by processor 111 at step 220 may comprise repeating process 204 from step 205 to resample candidate pairs. This may assist to find at least one candidate pair which meet the directionality criteria. In some embodiments further processing by processor 111 at step 220 may comprise determining the proportion of positive observations to total observations and then appending a leaf node based upon that determination based on a less stringent threshold. This may help complete a tree with sufficient discrimination ability meeting directionality requirements. In some embodiments, particularly if the tree or ensemble is shallow with no leaf nodes, further processing by processor 111 at step 220 may comprise rejecting the tree or ensemble, and then may restart the building of the tree or ensemble. Similar to the example above, with new sampling of candidate pairs, this may assist to finding a new tree or ensemble which has sufficient discrimination ability and meets directionality requirements.

At step 225, the processor 111 executing program code 113 is further caused to select a candidate table with the maximum information gain from the candidate tables stored in the table set at step 220 to complete process 204. Processor 111 then selects the variable and the decision criteria for a decision tree node associated with the selected candidate table. In some embodiments the measure of homogeneity calculated in step 215 is used as a basis for calculating and selecting the table with maximum information gain.

In some embodiments, the directionality table is updated by processor 111 with the directionality of the variable selected in step 225 after selection. In some embodiments, the information gain or weighted information gain of the selected variable and split combination is stored by processor 111 in a weighted information gain table in memory 112, 130 or 122. In some embodiments, the weighted information gain table is combined with the directionality table in a variable information table.

In some embodiments, steps 210, 215 and 220 are carried out in succession and reiterated for each split value and variable combination for all candidate pairs within the dataset, before step 225 commences.

Proceeding step 225, at step 235 the processor 111 executing program code 113 is further caused to assess whether the tree build is finished based on one or more decision criteria. In some embodiments, the decision criteria is met when the tree depth of the decision tree being generated has exceeded a threshold value. In some embodiments, the decision criteria is met when all branches from the latest created decision nodes in the tree are classified as leaf nodes,

If processor 111 determines that the tree build is not complete based on the criteria at step 235, at step 250 the processor 111 may further be caused to add unclassified branches from the node recently selected in step 204 to the pool of potential nodes to process.

Proceeding step 250, the processor 111 executing program code 113 is further caused to select a node from an unclassified branch in step 253. Following this selection of a node from a pool of nodes, the processor 111 is further caused to process the selected node by repeating process 204 for the new selected node with its partitioned dataset.

If processor 111 determines that the tree build is complete based on the decision criteria at step 235, at step 255 the processor 111 may further be caused to terminate branches which are yet to be classified. In some embodiments processor 111 classifies the unclassified branches in the termination step 255.

Proceeding step 255, at step 260 the processor 111 executing program code 113 may further be caused to store decision tree information in memory 112, 130 or 122. In some embodiments, storage of decision tree information has been already completed fully or in part during or between other steps within method 200. In some embodiments, decision tree information comprises data pertaining to the tree learnt, directionality table information, weighted information gain table and variable information table. In some embodiments the processor 111 is caused to calculate the aforementioned decision tree information in step 260 before storing.

Proceeding step 260, the processor 111 executing program code 113 is further caused to assess whether the ensemble is complete based on a decision at step 265. In some embodiments the criteria for decision step 265 is determined by the ensemble method which is being constrained by method 200.

If processor 111 determines that the ensemble is incomplete at decision step 265, the processor 111 executing program code 113 is further caused to start a new tree build in step 270. In some embodiments, the procedure for step 270 is determined by the ensemble method which is being constrained by method 200.

If processor 111 determines that the ensemble is complete at decision step 265, the processor 111 executing program code 113 is further caused to finish ensemble build and end the method 200 at step 275.

In some embodiments, at step 275 processor 111 executing program code 113 is further caused to store ensemble information in memory 112, 130 or 122. In some embodiments ensemble information comprises data pertaining to the ensemble learnt, data pertaining to the tree learnt, directionality table information, weighted information gain table and variable information table. In some embodiments the processor 111 is caused to calculate the aforementioned decision tree information at 275 before storing.

In some embodiments, at step 275 processor 111 executing program code 113 is further caused to calculate summary information of the built ensemble and store in memory 112, 130 or 122. In some embodiments, summary information comprises ensemble information. In some embodiments, the processor is further caused to send summary information from memory 112, 130 or 122 to I/O 115 whereby a user may attain summary information by a connected device such as a computer monitor.

While method 200 has been described as using entropy and Gini coefficient as the types of compatible criteria for building nodes of the tree in conjunction with directionality, in some embodiments other types of compatibility criteria might be used. For example, other information gain measures, cluster methods, and greedy methods may be used as compatibility criteria for building nodes of the tree in some embodiments.

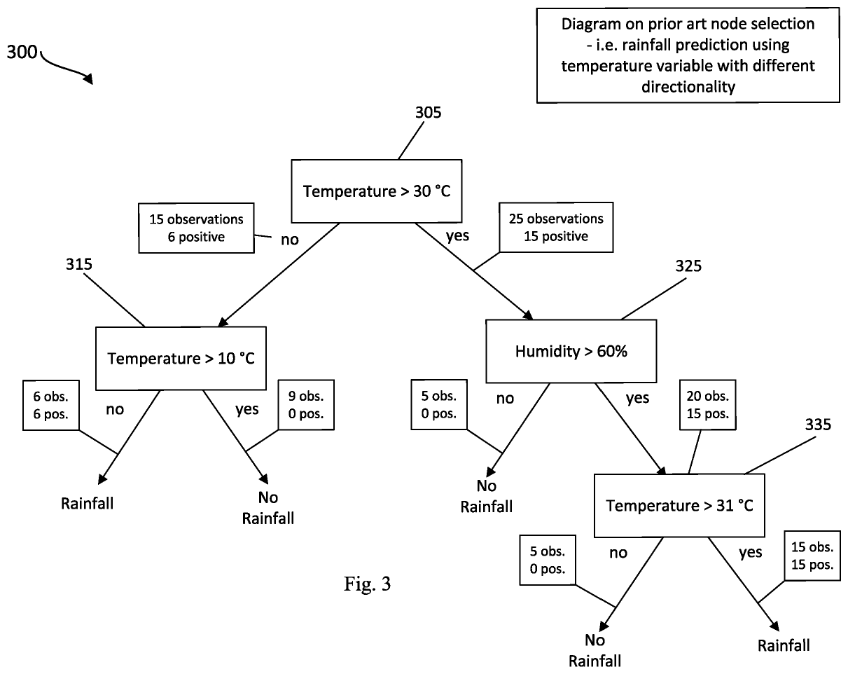

FIG. 3 shows a decision tree 300 of a decision tree ensemble created based on a method known in the art whereby directionality is not a constraint in the ensemble learning process. At decision tree node 305, a root node has been selected whereby the variable selected is temperature and the threshold criteria which has been selected is an inequality “greater than” 30° C. In the illustrated embodiment, there were initially 40 observations in the dataset.

Branching from the bottom left hand side of node 305 is an arrow “branch” which connects to decision node 315. The arrow is labelled with a box which indicates the branch has a partition of 15 of the 40 observations in the dataset, with none of the 15 partitioned observations having a temperature greater than 30° C. (indicated by “no”). 6 of those 15 observations had a positive occurrence of rainfall.

Branching from the bottom right hand side of node 305 is an arrow “branch” which connects to decision node 325. The arrow is labelled with a box which indicates the branch has a partition of 25 of the 40 observations in the dataset, which have a temperature greater than 30° C. (indicated by “yes”). 15 of those 25 observations had a positive occurrence of rainfall.

Therefore, at node 305, there is a greater proportion of positive observations (15/25=0.60) above the split value than below the split value (6/15=0.40). In this case it can be described that the directionality of the temperature variable at node 305 is of type “R” for right, as there is a greater proportion of positive occurrences on the right hand side branch than the left hand side branch.

The left hand side branch of node 305 points to node 315. Here a decision tree node has been selected whereby the variable selected is temperature and threshold criteria which has been selected is an inequality “greater than” 10° C. Node 315 was selected based on 15 observations comprising an intermediate dataset, being the 15 observations that did not have a temperature of greater than 30° C.

Branching from the bottom left hand side of node 315 is an arrow “branch” which connects to a leaf node which predicts rainfall. The arrow is labelled with a box which indicates the branch has a partition of 6 of the 15 observations in the intermediate dataset, of which none of the 6 partitioned observations have a temperature greater than 10° C. (indicated by “no”), and all 6 of those 6 observations had a positive occurrence of rainfall.

Branching from the bottom right hand side of node 315 is an arrow “branch” which connects to a leaf node which predicts no rainfall. The arrow is labelled with a box which indicates the branch has a partition of 9 of the 15 observations in the intermediate dataset, of which none of the 9 partitioned observations have a temperature greater than 10° C. (indicated by “no”), and 0 of those 9 observations had a positive occurrence of rainfall.

Therefore, at node 315, there is a greater proportion of positive observations (6/6=1.00) below the split value than above the split value (0/9=0.00). In this case it can be described that the directionality of the temperature variable at node 315 is of type L for left, as there is a greater proportion of positive occurrences on the left hand side branch than the right hand side branch. As it is assumed that the inequality sign for each occurrence of a split value for a particular variable is the same inequality sign, this type-L directionality in node 315 conflicts with the directionality seen at node 305. Therefore, it could not be unequivocally be stated that high temperatures predict rainfall in the generated model.

The right hand side branch of node 305 points to node 325. Here a decision tree node has been selected whereby the variable selected is humidity and the threshold criteria which has been selected is an inequality “greater than” 60%. Node 325 was selected based on 25 observations comprising an intermediate dataset, being the 25 observations that did have a temperature of greater than 30° C.

The right hand side branch of node 325 points to node 335. Here a decision tree node has been selected whereby the variable selected is temperature and threshold criteria which has been selected is an inequality “greater than” 31° C. Node 335 was selected based on 20 observations comprising an intermediate dataset, being the 20 observations from node 325 that had a humidity of greater than 60%.

Branching from the bottom left hand side of node 335 is an arrow “branch” which connects to a leaf node which predicts no rainfall. The arrow is labelled with a box which indicates the branch has a partition of 5 of the 20 observations in the intermediate dataset, of which none of the 5 partitioned observations have a temperature greater than 31° C. (indicated by “no”), and 0 of those 5 observations had a positive occurrence of rainfall.

Branching from the bottom right hand side of node 335 is an arrow “branch” which connects to a leaf node which predicts rainfall. The arrow is labelled with a box which indicates the branch has a partition of 15 of the 20 observations in the intermediate dataset, of which none of the 15 partitioned observations have a temperature greater than 31° C. (indicated by “no”), and all 15 of those 15 observations had a positive occurrence of rainfall.

Therefore, at node 335, there is a greater proportion of positive observations (15/15=1.00) above the split value than below the split value (0/5=0.00). In this case it can be described that the directionality of the temperature variable at node 335 is of type R, as there is a greater proportion of positive occurrences on the right hand side branch than the left hand side branch. This type-R directionality in node 335 conflicts with the directionality seen at node 315 but follows the directionality seen at the root node 305.

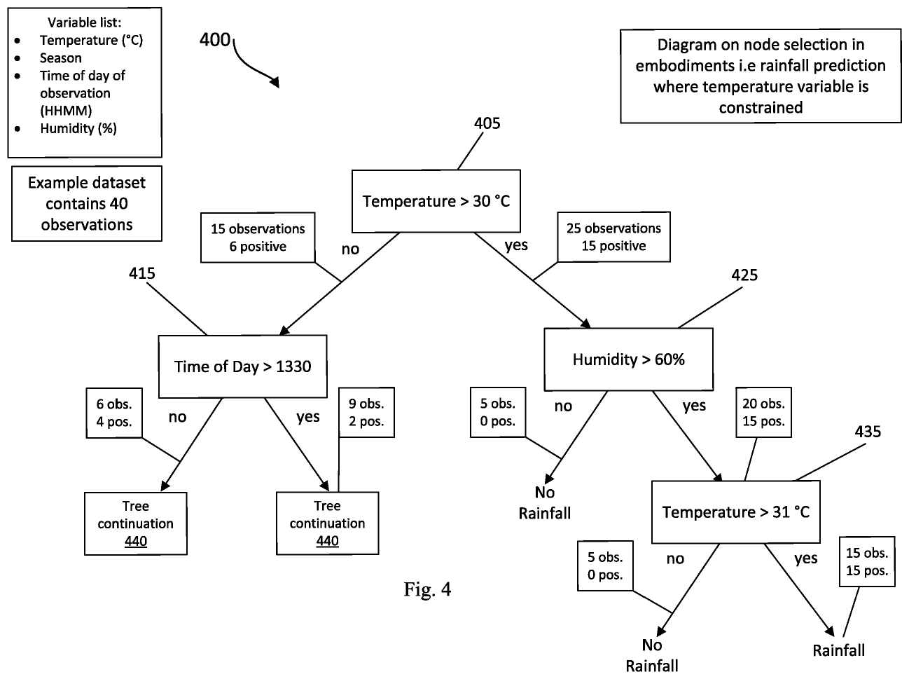

FIG. 4 shows a decision tree of a decision tree ensemble created by the system of FIG. 1 executing the method of FIG. 2 using the same dataset used in FIG. 3. In the decision tree of FIG. 4, directionality is an added constraint to the ensemble learning process of FIG. 3.

Root node 405 has been selected by processor 111 with the same variable and threshold value as root node 305 due to it being the first instance of temperature being used in the ensemble. Therefore once the node 405 is selected, the directionality table is updated registering that temperature is of type R for the rest of the ensemble build.

The left hand side branch of node 405 points to node 415. Node 415 is different to node 315, as processor 111 has selected the variable and the split criteria for node 415 based on the directionality of the node. Specifically, when considering whether to keep variable temperature for a threshold criteria “greater than” 10° C. during process step 215 of method 200, the processor 111 determines that the variable and threshold criteria does not partition the intermediate dataset so that the partitioned branches follow the directionality of type R as referenced in the directionality table.

Therefore the variable and split criteria which passes directionality with the lowest resulting entropy is chosen for decision node 415. This variable chosen is time of day and the split criteria is an inequality “greater than” for a split value of 1330. The resulting branches from node 415 do not partition the data perfectly, and therefore the tree continues for both branches 440.

The right hand side branch of node 405 points to node 425, which is unchanged from node 325 in FIG. 3 due to it being the first occurrence of the humidity variable in the constrained ensemble build.

The right hand side branch of node 425 points to node 435, which is unchanged from node 335 in FIG. 3 due to it complying with directionality of the temperature variable from the directionality table, and still providing the lowest entropy for candidate variable and split value combinations for the node.

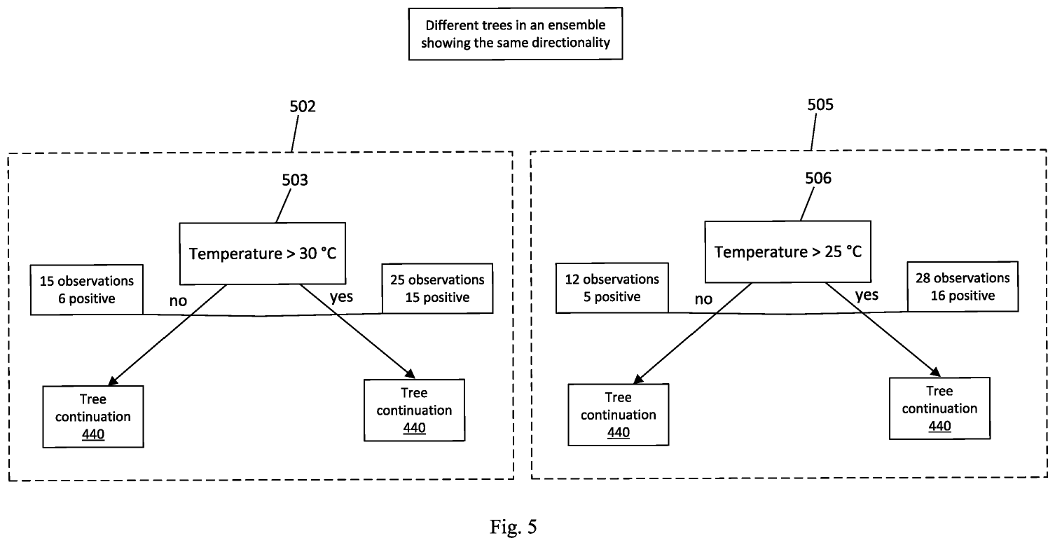

FIG. 5 shows multiple decision trees, 502 and 505, each of which comprise a decision tree ensemble learnt under the method 200.

Node 503 belongs to decision tree 502. Node 503 is a root node that has been selected. The variable selected is temperature and the threshold criteria which has been selected is an inequality “greater than” 30° C. In the illustrated embodiment, there were initially 40 observations in the dataset.

At node 503, there is a greater proportion of positive observations (15/25=0.60) above the split value than below the split value (6/15=0.40). In this case it can be described that the directionality of the temperature variable at node 503 is of type R for right, as there is a greater proportion of positive occurrences on the right hand side branch than the left hand side branch.

Node 506 belongs to decision tree 505. Node 506 is a root node that has been selected. The variable selected is temperature and the threshold criteria which has been selected is an inequality “greater than” 25° C. In the illustrated embodiment, there were initially 40 observations in the dataset.

At node 506, there is a greater proportion of positive observations (16/28=0.57) above the split value than below the split value (5/12=0.42). In this case it can be described that the directionality of the temperature variable at node 506 is of type R for right, as there is a greater proportion of positive occurrences on the right hand side branch than the left hand side branch.

Both root nodes, 503 and 506, exhibit the same type R directionality as each other, and therefore the method 200 has allowed their concurrent selections in the learnt model.

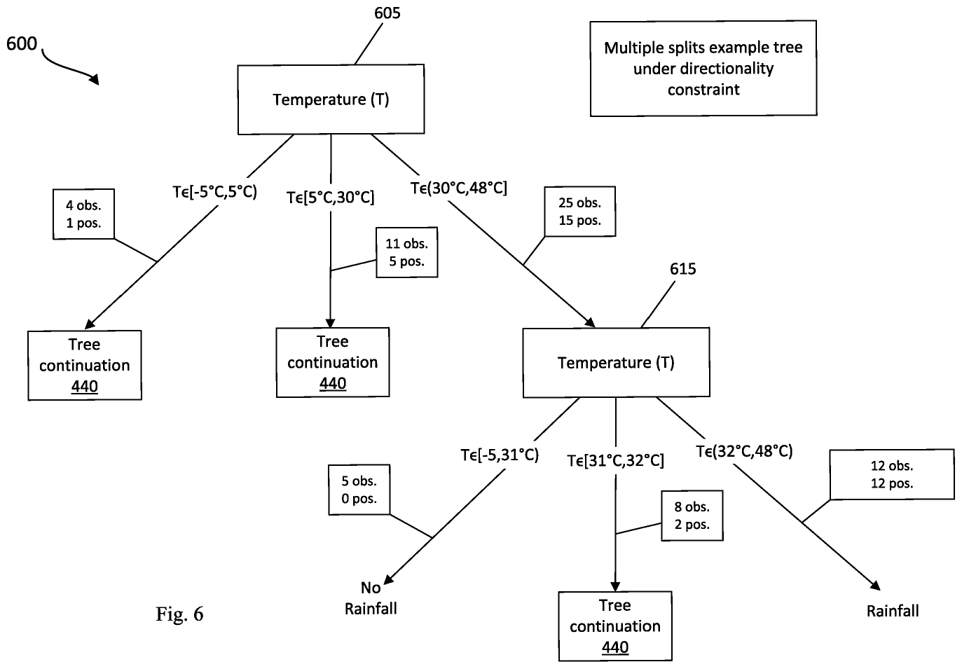

FIG. 6 shows a decision tree built by processor 111 executing method 200 wherein decision nodes have more than two branches.

At decision node 605 the temperature variable has been selected, and the criteria selected partitions the observations set based on three ranges of temperature values. The right most branch has the highest range of temperature values, the central branch has the next highest range of temperature values, while the leftmost branch has the lowest range of temperature values. The right most branch has the greatest proportion of positive observations (15/25=0.60), the central branch has the next highest proportion of positive observations (5/11=0.45), while the leftmost branch has the lowest proportion of positive observations (1/4=0.25). This establishes a directionality ranking for temperature branches which is registered in the directionality table by processor 111 executing method 200 once node 605 is selected.

In some embodiments the processor 111 may record this as a sequence of numbers, such as “321”, for example. In this case, the 1 represents the branch with the highest proportion of positive observations and the next successive increments of integers represents progressively lower proportions of positive observations. The lowest temperature range/left branch represents the leftmost digit and the highest temperature range/right branch is represented by the rightmost digit.

At node 615, processor 111 executing method 200 allows the temperature variable to be selected with three branches again, whereby directionality ranking “321” established with the temperature entry directionality table is complied with.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1-2. (canceled)

3. A method for generating an artificial intelligence model by applying a decision tree ensemble learning process on a dataset, the method comprising:
receiving a dataset comprising at least two variables;
determining at least one split criteria for each variable within the dataset;
partitioning the dataset based on each determined split criteria;
calculating a measure of directionality for each partition of data;
performing a constrained node selection process by selecting a candidate variable and split criteria, wherein the selection is made to keep a consistent directionality for the selected variable based on existing nodes;
updating a directionality table at the end of a constrained node selection; and
reiterating the constrained node selection process for every node selection throughout the decision tree ensemble learning process until an ensemble model is generated.

4. The method of claim 3, wherein the constrained node selection process comprises:
generating groups of split criterions for each of one or more variables of the dataset, creating one or more variable and split criteria combinations;
copying the dataset for every variable and split criteria combination;
partitioning each copied dataset by its associated split criteria for a variable and store resulting partitioned datasets each in a candidate table for each variable and split criteria combination;
calculating a measure of homogeneity and directionality for each candidate table;
storing all candidate tables which pass directionality criterion in a table set;
selecting one of the candidate tables of the table set which has the optimal measure of homogeneity;
storing the associated variable and split criteria combination of the selected candidate table as a chosen candidate for the node; and
storing the partitioned data from selected table to use as new datasets for selection of decision nodes or leaf nodes, which branch from the selected node.

5. The method of claim 3, wherein updating a directionality table comprises entering directionality information of the selected candidate variable and split value into the directionality table.

6. The method of claim 3, wherein the directionality table is also updated with cumulative weighted information gain calculation for the associated variable.

7. The method of claim 3, wherein cumulative weighted information gain for the associated variable is calculated at the end of the learning process.

8. The method of claim 3, wherein the directionality table is not updated with directionality information for the selected candidate variable when the directionality table already contains directionality information for the selected candidate variable.

9. The method of claim 4, wherein candidate tables pass the directionality criterion if they match directionality with entries in the directionality table or if they have no entries in the directionality table.

10. (canceled)

11. The method of claim 3, wherein the method is applied to random forest or a gradient boosted trees learning methods.

12. The method of claim 3, wherein the dataset comprises at least one of a continuous variable and a categorical variable.

13. The method of claim 4, wherein one or more split values are assigned to a candidate table for a continuous variable.

14. (canceled)

15. The method of claim 4, wherein two or more categories are assigned to a candidate table for a categorical variable instead of a one or more split values.

16. The method of claim 4, wherein the measure of homogeneity is at least one of entropy and Gini.

17. (canceled)

18. The method of claim 4, further comprising presenting the user with weighted information gain and directionality information for each variable used in the ensemble at the end of the learning process.

19. The method of claim 18, wherein the weighted information gain and directionality information for each variable is sorted based on weighted information gain.

20. The method of claim 3, wherein the weighted information gain is calculated per leaf node, whereby each decision node in which the leaf node is dependent upon is factored into the weighted information gain calculation.

21. The method of claim 20, wherein the weighted information gain and directionality information per variable per leaf node is available to be presented or is presented to the user.

22. The method of claim 4, wherein if two or more candidate decision nodes selected at a processing stage, whereby each use the same variable and have conflicting directionality, and no directionality is yet determined, the selected node or nodes of a directionality which best meet a conflict criteria are kept, and the other selected node or nodes of another directionality are rejected.

23. The method of claim 22, wherein the conflict criteria is at least one of: the highest information gain or weighted information gain of a node; the highest total information gain or total weighted information gain of nodes grouped by directionality; the largest number of observations of a node; the largest number of observations grouped by their respective node's directionality the earliest selection time of a node; or the largest number of candidate decision nodes grouped by directionality.

24-27. (canceled)

28. A system for constraining a decision tree ensemble machine learning process to generate an artificial intelligence model for a dataset, the system comprising:
a processor;
memory storing program code that is accessible and executable by the processor; and
wherein, when the processor executed the program code, the processor is caused to:
apply directionality as a criterion for a constrained node selection process in order to select a selected candidate variable and split value for a node;
update a directionality table at the end of a constrained node selection; and
reiterate the process for every node selection throughout a decision tree ensemble build.

29. A system for constraining a decision tree ensemble machine learning process to generate an artificial intelligence model for a dataset, the system comprising:
a processor;
memory storing program code that is accessible and executable by the processor; and
wherein, when the processor executed the program code, the processor is caused to perform operations comprising:
receiving a dataset comprising at least two variables;
determining at least one split criteria for each variable within the dataset;
partitioning the dataset based on each determined split criteria;
calculating a measure of directionality for each partition of data;
performing a constrained node selection process by selecting a candidate variable and split criteria, wherein the selection is made to keep a consistent directionality for the selected variable based on existing nodes;
updating a directionality table at the end of a constrained node selection; and
reiterating the constrained node selection process for every node selection throughout the decision tree ensemble learning process until an ensemble model is generated.
